(19) United States
(12) Patent Application Publication
(10) Pub. No.: US 2005/0041818 A1
(43) Pub. Date: Feb. 24, 2005

(54) USP power amplified trumpet connecting device

(76) Inventor: Tseng-Tien Peng, Taipei Hsien (TW)

Correspondence Address: Tseng-Tien Peng, 235 Chung-Ho Box 8-24, Taipei, TW

(21) Appl. No.: 10/642,483

(22) Filed: Aug. 18, 2003

(51) Int. Cl. H04B 3/00

(52) U.S. Cl. 381/77; 381/111

(57) ABSTRACT

A USP power amplified trumpet connecting device is disclosed. A digital conversion chip and a power amplifier chip are installed to one USB port for being further connected to a trumpet so as to emit sound directly. Moreover, an output connector can be included. Thus the use of the USP power amplified trumpet connecting device is easy and can be portable easily. Moreover, the output connector can be connected to a trumpet and an earphone. The output connector is an optical fiber output connector which is connected to a decoder or an amplifier with optical fiber input so as to emit sound. The output connector includes a general used output and an optical fiber terminal for being connected to an optical fiber output, an earphone or an trumpet.

### FIELD OF THE INVENTION

The present invention relates to USP devices, and particularly to a USP power amplified trumpet connecting device

### BACKGROUND OF THE INVENTION

In general, a trumpet need an AC power wire, a transformer, and USB wires. Moreover, circuit board is installed in a sound box so that the volume of the sound box is large and this it is inconvenient to carry out the trumpet. Moreover, the installation process is complicated and power can not be improved and sound quality is bad. Cost is high. Thereby, the use of the trumpet is confined and can not be used widely.

### SUMMARY OF THE INVENTION

Accordingly, the primary object of the present invention is to provide a USP power amplified trumpet connecting device. A digital conversion chip and a power amplifier chip are installed to one USB port for being further connected to a trumpet so as to emit sound directly. Moreover, an output connector can be included. Thus the use of the USP power amplified trumpet connecting device is easy and can be portable easily. Moreover, the output connector can be connected to a trumpet and an earphone. The output connector is an optical fiber output connector which is connected to a decoder or an amplifier with optical fiber input so as to emit sound. The output connector includes a general used output and an optical fiber terminal for being connected to an optical fiber output, an earphone or a trumpet.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

FIG. 2 is a perspective view of the present invention.

FIG. 3 shows one embodiment of the output connector of the present invention.

FIG. 4 shows another embodiment of the output connector of the present invention.

FIG. 5 shows yet an embodiment of the output connector of the present invention.

FIG. 6 shows a schematic view about the output device of the present invention.

FIG. 7 is a schematic view about the connection of the present invention and a personal computer.

FIG. 8 is a schematic view showing the connection of the present invention and a notebook computer.

FIG. 9 is a schematic view showing the chip (including a digital conversion chip and a power amplifier chip) of the present invention.

FIG. 10 is a schematic view showing the chip of the present invention.

### DETAILED DESCRIPTION OF THE PREFERRED EMBODIMENTS

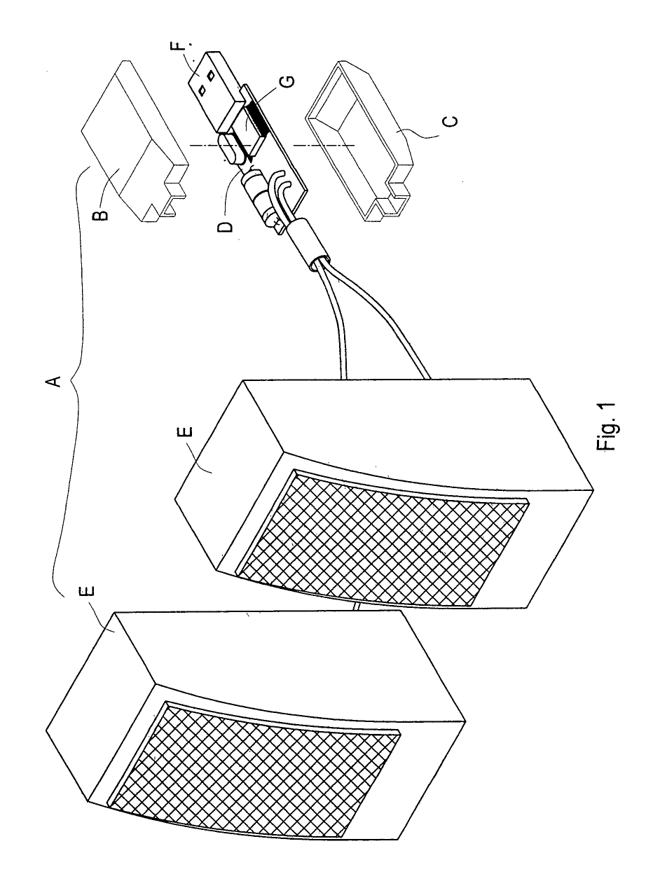

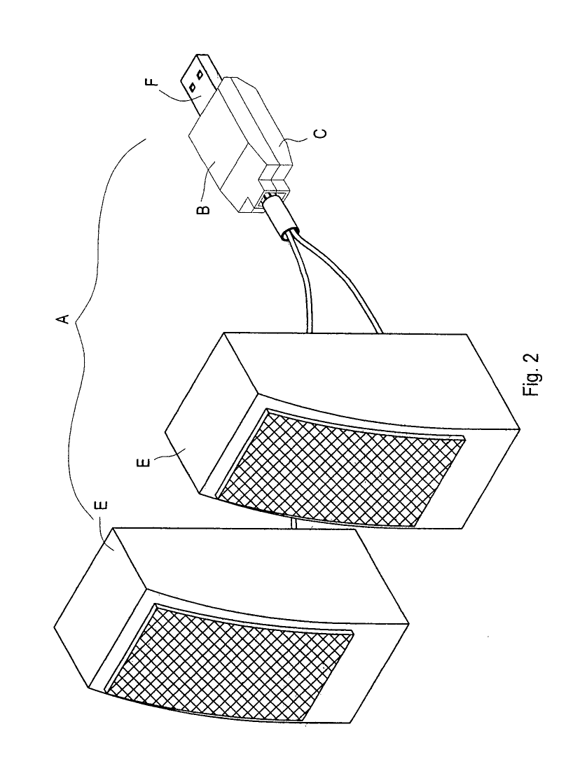

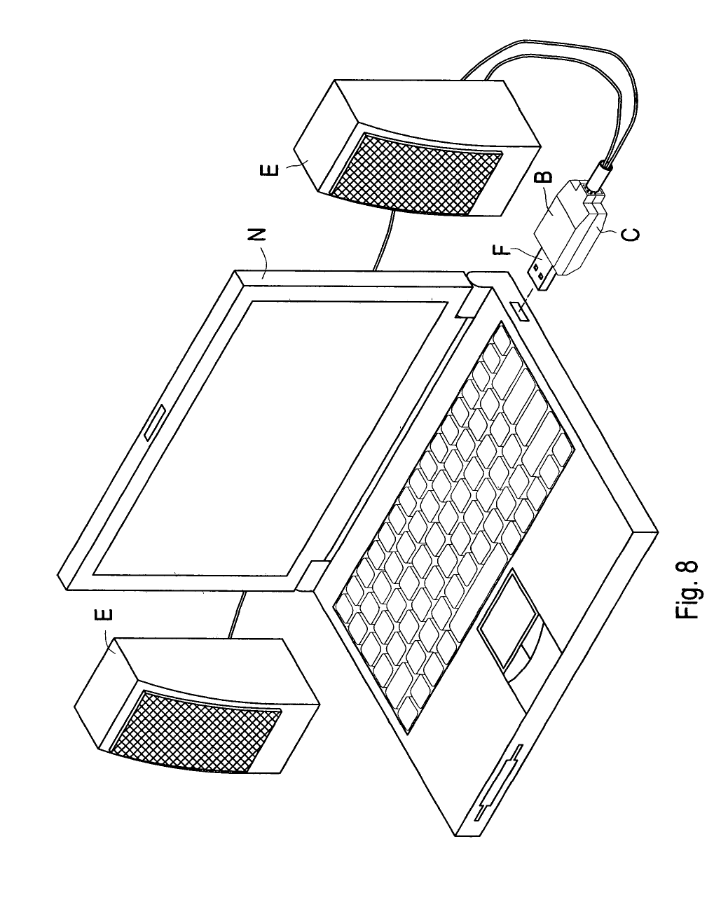

Referring to FIG. 1, the USP power amplified trumpet connecting device of the present invention is illustrated. The USP power amplified trumpet connecting device A is formed by an upper cover B, a lower cover C, a circuit board D, and a trumpet E. Chips (a digital conversion chip and a power amplifier chip) G are installed on the circuit board D and is connected to the USB port F. The connection of the upper cover B and lower cover C are illustrated in FIGS. 2 and 8. The USP power amplified trumpet connecting device A of the present invention is combined to a USP slot of a personal computer H through the USB port F.

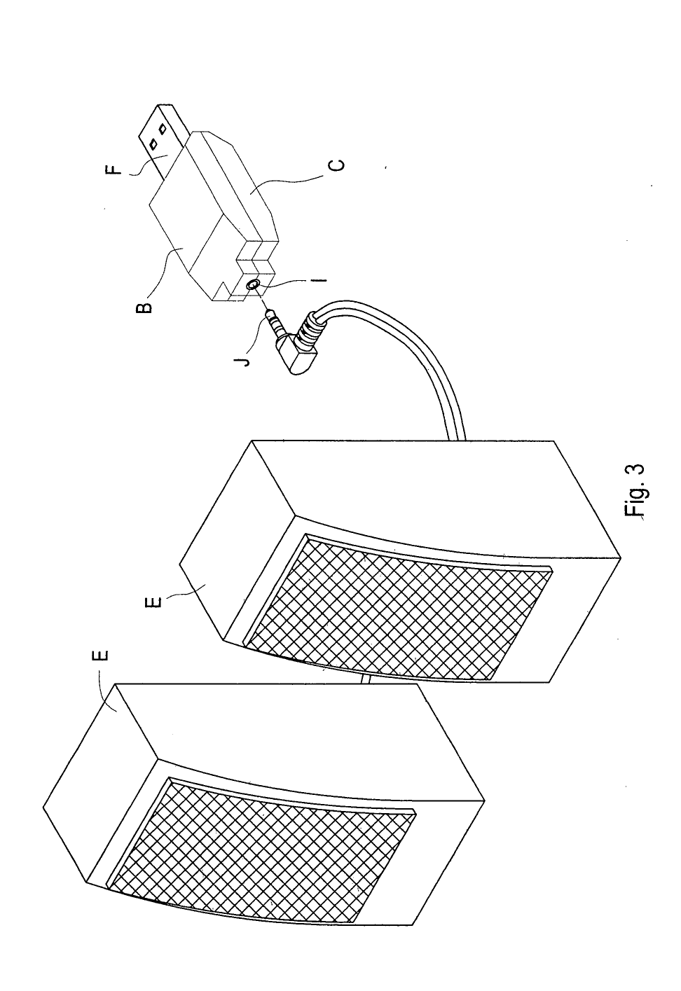

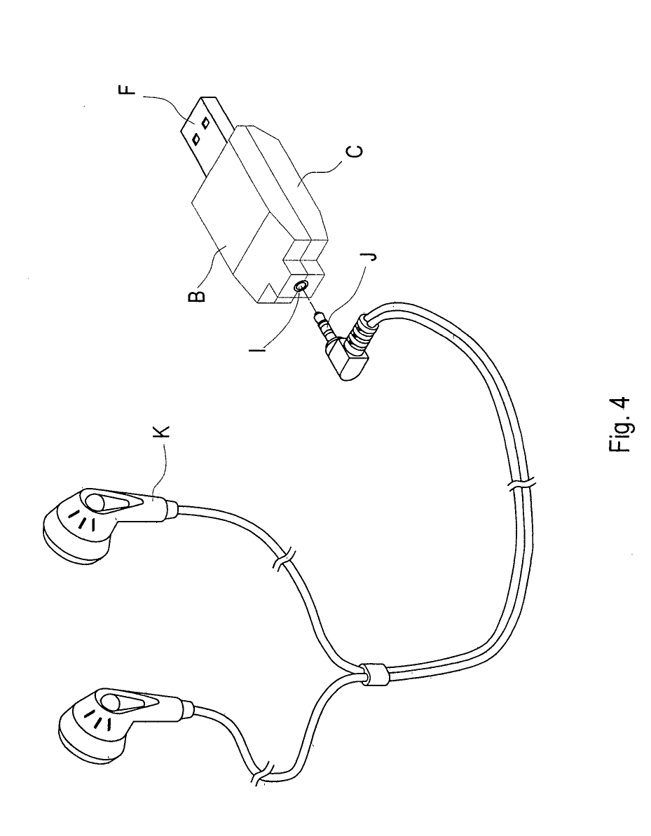

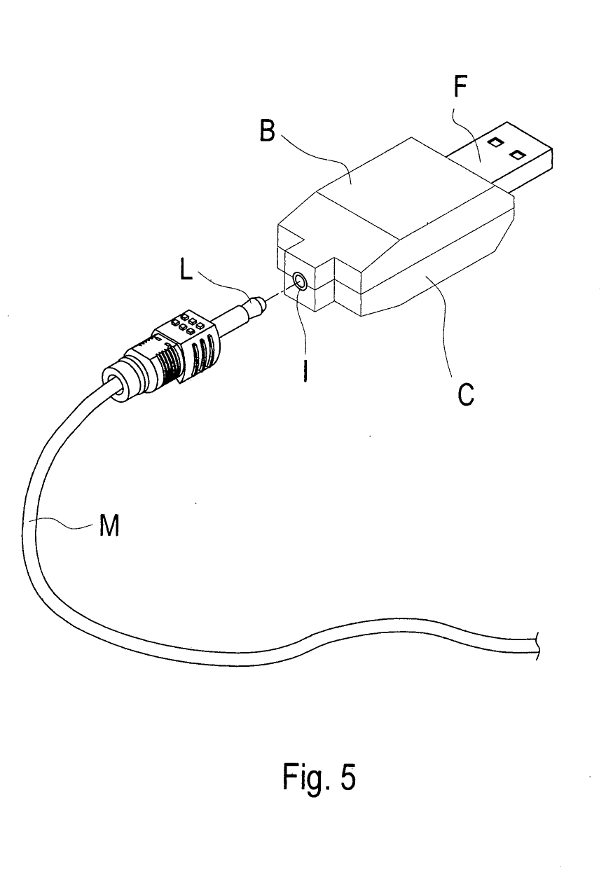

With reference to FIGS. 3 and 4, the USP power amplified trumpet connecting device A can be used with trumpets E or earphones K through an output connector or is connected to an optical fiber terminal L, as shown in FIG. 5. In another example, the output connector I can be a dual-use connector which can be connected to an optical fiber terminal L or an earphone terminal J.

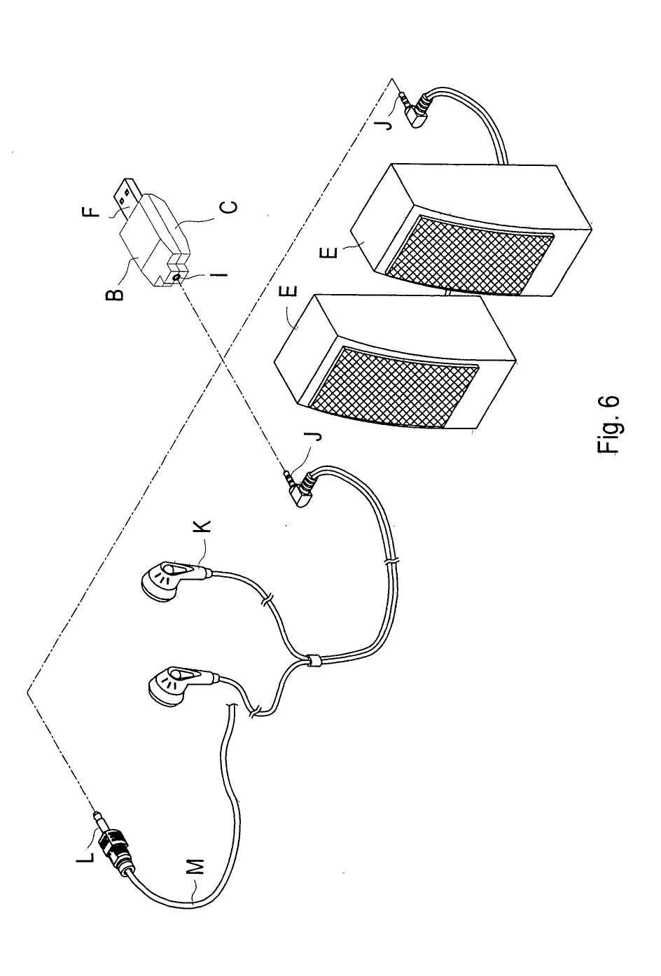

In the present invention, the output device is selectable as desired since the output connector I can be connected to a trumpet E, an earphone K and an optical fiber line M as illustrated in FIG. 6. FIG. 6 is a schematic view shows the whole assembly of the output device of the present invention.

Despite the output device, the present invention can be connected to a personal computer H through a USB port F. Then the signals are processed by chips G (a digital conversion chip and a power amplify chip) and then are converted for outputting to another device.

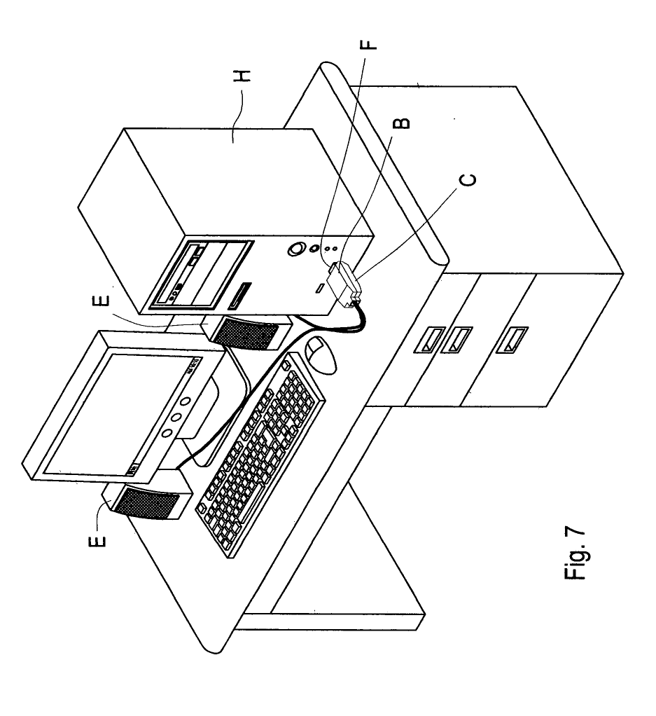

Referring to FIGS. 7 and 8, two embodiment of the USP power amplified trumpet connecting device A of the present invention is illustrated. In the drawings, it is shown that the personal computer H and notebook computer N are installed with respective USB slots. The personal computer H or notebook computer N can be connected to the USP power amplified trumpet connecting device A through the slot.

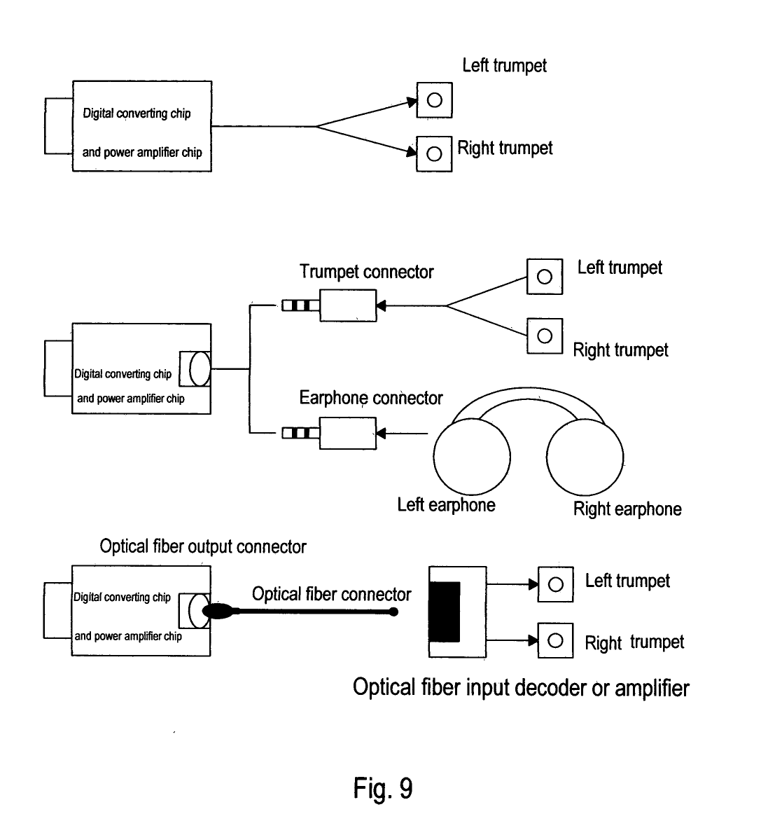

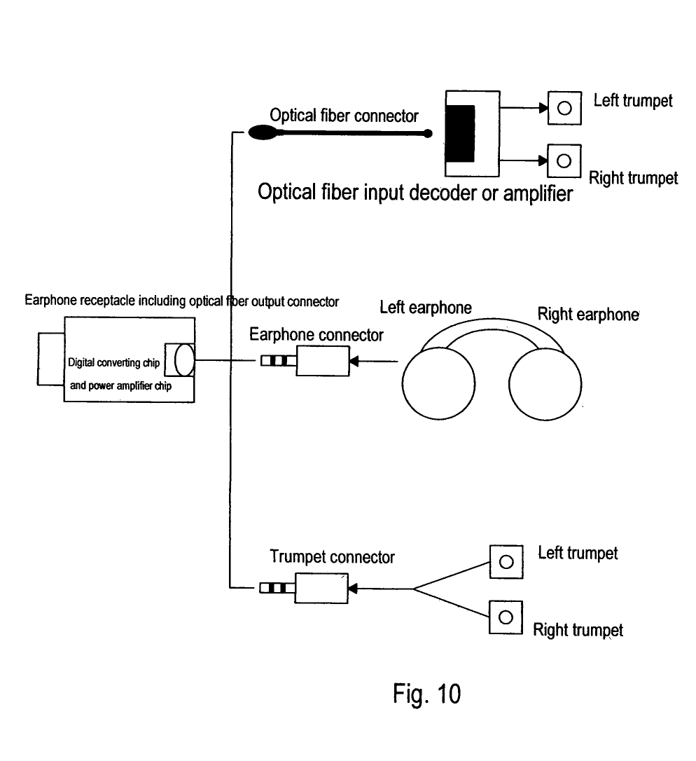

With reference to FIGS. 9, and 10, the connection of the output device and the chip G is illustrated. From the drawing, it is shown that the present invention is a multiple use device. Moreover, the chip G can be used in the voice process so as to get a preferred voice effect.

The advantages of the present invention will be described herein. In the present invention, the circuit of the circuit board is not in the trumpet box and thus a preferred sound effect can be got and the size of the sound box can be reduced. The assembly work can be performed easily by anybody. In the present invention, no transformer is used. The digital conversion chip and power amplifier chip are installed at the same USB port so that the power is increased and the cost is reduced. Moreover, in the present invention, many connection ways are usable.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A USP power amplified trumpet connecting device; wherein a digital conversion chip and a power amplifier chip are installed to one USB port for being further connected to a trumpet so as to emit sound directly, thus the use of the USP power amplified trumpet connecting device is easy and is portable conveniently.

2. A USP power amplified trumpet connecting device; wherein a digital conversion chip, a power amplifier chip and an output connector are installed to one USB port.

3. The USP power amplified trumpet connecting device as claimed in claim 2, wherein the output connector is connected to a trumpet and an earphone.

4. The USP power amplified trumpet connecting device as claimed in claim 2, wherein the output connector is an optical fiber output connector which is connected to a decoder or an amplifier with optical fiber input so as to emit sound.

5. The USP power amplified trumpet connecting device as claimed in claim 2, wherein the output connector includes a general used output and an optical fiber terminal for being connected to an optical fiber output, an earphone or an trumpet.
